(19) United States
(12) Patent Application Publication
(10) Pub. No.: US 2024/0051752 A1
(43) Pub. Date: Feb. 15, 2024

(54) PARTS BOX MANAGEMENT SYSTEM AND PARTS BOX MANAGEMENT METHOD

(71) Applicant: HONDA MOTOR CO., LTD., Tokyo (JP)

(72) Inventors: Takashi OKADA, Tokyo (JP); Daisuke HASHIMOTO, Tokyo (JP); Shinji TANINO, Tokyo (JP); Nozomu SAIBARA, Tokyo (JP); Souphatsone THEPPHOUMY, Tokyo (JP); Saeko KOMATSU, Tokyo (JP); Hiroaki NOMOTO, Tokyo (JP); Atsushi ITO, Tokyo (JP); Katsuyoshi TSUTSUMIDA, Tokyo (JP); Kenji TATSUDA, Tokyo (JP); Gentoku FUJII, Tokyo (JP); Hiroshi HOSHINO, Tochigi (JP)

(21) Appl. No.: 18/260,336

(22) PCT Filed: Dec. 28, 2021
(86) PCT No.: PCT/JP2021/048807

§ 371 Date: Jul. 5, 2023

(30) Foreign Application Priority Data
Jan. 8, 2021 (JP) 2021-002070

(51) Int. Cl. B65G 1/137

(52) U.S. Cl. CPC B65G 1/137

(57) ABSTRACT

A bucket management system 1 comprises: chutes 2 and 3 that have loading areas I1 and I4 and take-out areas O1 and O4 facing each other along a conveying direction F and convey buckets loaded to the loading area along the conveying direction F in storage areas S1 and S4 between the loading areas and the take-out areas; and a loading position indicating device 5 that indicates a loading position P for a bucket to be loaded along the width direction in the loading area. A plurality of bucket rows configured by stacking a plurality of buckets along the conveying direction F can be arranged in the storage areas. The loading position indicating device 5 indicates a loading position P on the basis of the lot number allocated to a bucket to be loaded and the arrangement information of the buckets in the storage areas.

### TECHNICAL FIELD

The present invention relates to a parts box management system and a parts box management method. More specifically, the present invention relates to a parts box management system and a parts box management method for managing arrangement positions of a plurality of parts boxes in a storage area.

### BACKGROUND ART

A vehicle manufacturing line for continuously producing vehicles of different models in predetermined lot units is configured with a plurality of manufacturing lines. For example, Patent Document 1 shows a vehicle manufacturing line provided with a main line that includes a painting line, a vehicle assembly line and the like, and sub-lines for assembling sub-parts (for example, a door) to be assembled to each vehicle body on the vehicle assembly line.

Further, for example, Patent Document 2 shows a method for efficiently supplying a plurality of door parts (for example, a speaker, an interior panel, a power window regulator, a sash mall, and a door mirror) to be assembled to each door panel on the door manufacturing line as a sub-line. More specifically, first, in a warehousing process, a plurality of buckets carried in from external parts manufacturers are temporarily stored in a storage area. In each bucket, a plurality of parts per lot are included. After that, in a set packing process, door parts for one vehicle are taken out from the plurality of buckets stored in the storage area and loaded onto a set pack carriage. After that, in a delivery process, the set pack carriage prepared in the set packing process is delivered to the door manufacturing line.
Patent Document 1: Japanese Unexamined Patent Application, Publication No. 2000-15530
Patent Document 2: Japanese Patent No. 6723315

### DISCLOSURE OF THE INVENTION

### Problems to be Solved by the Invention

In a conventional warehousing process, a plurality of buckets carried in from parts manufacturer are not arranged in any particular order in a storage area because the timing of buckets being carried in from outside is different among the parts manufacturers. Therefore, in order to facilitate work in the subsequent set packing process, it is necessary to re-arrange the plurality of buckets arranged in the storage area once in order of lot number, and it is therefore necessary to secure a large storage area.

An object of the present invention is to provide a parts box management system and a parts box management method making it possible to reduce a storage area for temporarily storing a plurality of parts boxes while facilitating work in a set packing process.

### Means for Solving the Problems

(1) A parts box management system according to the present invention (for example, a bucket management system 1 described later) includes: chutes (for example, a multi-stage chute 2 and a single-stage chute 3 described later), the chutes including put-in areas (for example, put-in areas I1, I2, I3, I4, and In described later) and take-out areas (for example, take-out areas O1, O2, O3, O4, and On described later), the put-in areas and the take-out areas extending along a width direction, the put-in areas facing the take-out areas, respectively, in a line direction (for example, a conveying direction F described later) that crosses the width direction, and the chutes conveying parts boxes (for example, buckets Ba, Bb, and Bc described later) put into the put-in areas, along the line direction in storage areas (for example, storage areas S1, S2, S3, S4, and Sn described later) between the put-in areas and the take-out areas until the parts boxes reach the take-out areas or come into contact with parts boxes put in earlier; and a put-in position indicator (for example, a put-in position indicator 5 described later) indicating a put-in position (for example, a put-in position P described later) for a put-in target parts box (for example, the put-in target bucket Bc described later) along the width direction in any of the put-in areas. In each of the storage areas, a plurality of lines of parts boxes can be arranged along the width direction, each of the plurality of lines of parts boxes being configured by stacking a plurality of parts boxes along the line direction; and the put-in position indicator indicates the put-in position based on a lot number assigned to the put-in target parts box and parts boxes arrangement information about the storage areas.

(2) In this case, it is favorable that the put-in position indicator indicates the put-in position based on shape information about the put-in target parts box.

(3) In this case, it is favorable that the put-in position indicator indicates the put-in position so that, in any of the storage areas, the plurality of parts boxes constituting each of the lines of parts boxes are arranged in order of the lot number from the take-out area side toward the put-in area side.

(4) In this case, it is favorable that the put-in position indicator indicates the put-in position so that parts boxes with a same lot number are not arranged along the line direction in the storage area.

(5) In this case, it is preferable that the put-in position indicator indicates the put-in position so that, in a case of arranging the put-in target parts box in a state of being stacked on stacking target parts boxes already existing in the storage area, along the line direction, a rate of overlap of the put-in target parts box relative to a stacking target parts box in front on the take-out area side, among the stacking target parts boxes, is equal to or above a predetermined threshold.

(6) In this case, it is preferable that the put-in position indicator indicates the put-in position so that variation in length along the line direction, among the plurality of lines of parts boxes existing in the storage area, is reduced.

(7) In this case, it is preferable that the chutes include restriction mechanisms (for example, stoppers 28 described later) that restrict a parts box conveyed from the put-in area side toward the take-out area side in the storage areas in movement along the width direction and in rotation in plan view.

(8) In this case, it is preferable that there is further provided a take-out position indicator (for example, a take-out position indicator 6 described later) indicating a take-out position of a take-out target parts box along the width direction in any of the take-out areas, based on the parts boxes arrangement information about the storage areas.

(9) A parts box management method according to the present invention is a parts box management method for managing arrangement positions of a plurality of parts boxes using chutes (for example, the multi-stage chute 2 and the single-stage chute 3 described later), the chutes including put-in areas (for example, the put-in areas I1, I2, I3, I4, and In described later) and take-out areas (for example, the take-out areas O1, O2, O3, O4, and On described later), the put-in areas and the take-out areas extending along a width direction, the put-in areas facing the take-out areas, respectively, in a line direction (for example, the conveying direction F described later) that crosses the width direction, and the chutes conveying parts boxes (for example, the buckets Ba, Bb, and Bc described later) put into the put-in areas, along the line direction in storage areas (for example, the storage areas S1, S2, S3, S4, and Sn described later) between the put-in areas and the take-out areas until the parts boxes reach the take-out areas or comes into contact with parts boxes put in earlier, the parts box management method including the steps of: acquiring a lot number assigned to a put-in target parts box (for example, the bucket Bc described later) (for example, step ST3 in FIG. 7 described later); acquiring parts boxes arrangement information about the storage areas (for example, Step ST2 in FIG. 7 described later); and indicating a put-in position (for example, the put-in position P described later) for the put-in target parts box along the width direction in any of the put-in areas based on the lot number, and the arrangement information (for example, steps ST4 to ST9 in FIG. 7 described later); and, in the storage area, a plurality of lines of parts boxes can be arranged along the width direction, each of the plurality of lines of parts boxes being configured by stacking a plurality of parts boxes along the line direction.

(10) In this case, the parts box management method further includes a step of acquiring shape information about the put-in target parts box (for example, step ST1 in FIG. 7 described later); and it is favorable that the put-in position is indicated based on the lot number, the arrangement information, and the shape information.

### Effects of the Invention

(1) A parts box management system according to the present invention includes: a chute including a put-in area and a take-out area, the put-in area and the take-out area extending along a width direction and facing each other in a line direction, and conveying a parts box put into the put-in area, along the line direction in a storage area until the parts box reaches the take-out area or comes into contact with a parts box put in earlier; and a put-in position indicator indicating a put-in position for a put-in target parts box along the width direction in the put-in area. In the storage area, a plurality of lines of parts boxes can be arranged along the width direction, each of the plurality of lines of parts boxes being configured by stacking a plurality of parts boxes along the line direction; and the put-in position indicator indicates the put-in position based on a lot number assigned to the put-in target parts box and parts boxes arrangement information about the storage area. Therefore, according to the present invention, a worker can arrange a put-in target parts box at a position appropriate for a lot number of the put-in target parts box, only by putting the put-in target parts box at a put-in position indicated by the put-in position indicator, in the put-in area extending in the width direction. More specifically, for example, when a plurality of parts boxes are arranged in the storage area so that a parts box with a low lot number is located at the front of each of lines of parts boxes, in other words, so that parts boxes with low lot numbers are arranged along the take-out area, a worker can, in a subsequent set packing process, take out necessary parts from the parts boxes arranged in the take-out area, among the plurality of parts boxes arranged in the storage area, and, therefore, it is possible to facilitate work in the set packing process. Further, in the present invention, it is possible to, by making it possible to arrange a plurality of lines of parts boxes in the storage area, efficiently arrange parts boxes of various sizes in the storage area. Therefore, it is also possible to reduce the storage area.

(2) In the present invention, the put-in position indicator indicates the put-in position based on shape information about the put-in target parts box in addition to the lot number and the arrangement information. Thereby, it is possible to more efficiently arrange parts boxes of various sizes in the storage area.

(3) In the present invention, the put-in position indicator indicates the put-in position for the put-in target parts box so that, in the storage area, the plurality of parts boxes constituting each of the lines of parts boxes are arranged in order of the lot number from the take-out area side toward the put-in area side. Thereby, it is possible to arrange a parts box with the lowest lot number at the front of each of a plurality of lines arranged in the storage area, and, therefore, it is possible to facilitate the work in the subsequent set packing process.

(4) In the present invention, the put-in position indicator indicates the put-in position so that parts boxes with the same lot number are not arranged along the line direction in the storage area. Thereby, a worker in the set packing process can cause only what is at the front of each of a plurality of lines of parts boxes arranged in the storage area, in other words, only those arranged in the take-out area to be work targets, and, therefore, it is possible to further facilitate the work in the set packing process.

(5) In the present invention, the put-in position indicator indicates the put-in position so that, in a case of arranging the put-in target parts box in a state of being stacked on stacking target parts boxes already existing in the storage area, along the line direction, a rate of overlap of the put-in target parts box relative to a stacking target parts box in front on the take-out area side, among the stacking target parts boxes, is equal to or above a predetermined threshold. Thereby, the width of each of lines of parts boxes in the storage area can be reduced as far as possible, and, therefore, it is possible to further reduce the storage area. Further, thereby, it is also possible to prevent a parts box stacked on stacking target parts boxes on the put-in area side along the line direction from getting out of a line of parts boxes.

(6) In the present invention, the put-in position indicator indicates the put-in position so that variation in length along the line direction, among the plurality of lines of parts boxes existing in the storage area, is reduced. Thereby, the length of the storage area along the line direction can be shortened, and, therefore, it is possible to further reduce the storage area.

(7) In the present invention, the chute includes a restriction mechanism that restricts a parts box conveyed from the put-in area side toward the take-out area side in the storage area in movement along the width direction and in rotation in plan view. Thereby, it is possible to prevent a parts box put into the put-in area from moving to an unintended place.

(8) In the present invention, a take-out position indicator indicates a take-out position of a take-out target parts box along the width direction in the take-out area, based on the parts boxes arrangement information about the storage area. Thereby, a worker in the set packing process can take out a necessary part only by taking out the part from a parts box at a take-out position indicated by the take-out position indicator, and, therefore, it is possible to further facilitate the work in the set packing process.

(9) In a parts box management method according to the present invention, by specifying a put-in position for a put-in target parts box along a width direction in a put-in area, based on a lot number assigned to the put-in target parts box and parts boxes arrangement information about a storage area, a worker can arrange the put-in target parts box at a position appropriate for the lot number only by putting the put-in target parts box at the indicated put-in position in the put-in area extending in the width direction. Thereby, similarly to the invention according to (1) above, it is possible to facilitate the work in the set packing process and reduce the storage area.

(10) In the present invention, shape information about the put-in target parts box is acquired, and the put-in position for the put-in target parts box is indicated based on the lot number, the arrangement information, and the shape information. Thereby, it is possible to more efficiently arrange parts boxes of various sizes in the storage area.

### BRIEF DESCRIPTION OF THE DRAWINGS

FIG. 1 is a diagram schematically showing a plane configuration of a bucket management system, a warehousing area, and a set packing area according to an embodiment of the present invention;

FIG. 2 is a perspective view of a multi-stage chute and a single-stage chute seen from the set packing area side;

FIG. 3A is a side view of the multi-stage chute;

FIG. 3B is a side view of the single-stage chute;

FIG. 4 is a plan view of a shelf board;

FIG. 5 is a sectional view along a line V-V parallel to a conveying direction of the shelf board;

FIG. 6 is a plan view of the shelf board;

FIG. 7 is a flowchart showing a specific procedure for a put-in position calculation process;

FIG. 8 is a diagram showing an example of a table for determining candidate areas and priority;

FIG. 9 is a diagram showing an example of possible put-in ranges; and

FIG. 10 is a diagram for illustrating a procedure for a put-in position calculator calculating an optimal put-in position.

### PREFERRED MODE FOR CARRYING OUT THE INVENTION

A bucket management system and a bucket management method according to an embodiment of the present invention will be described below with reference to drawings.

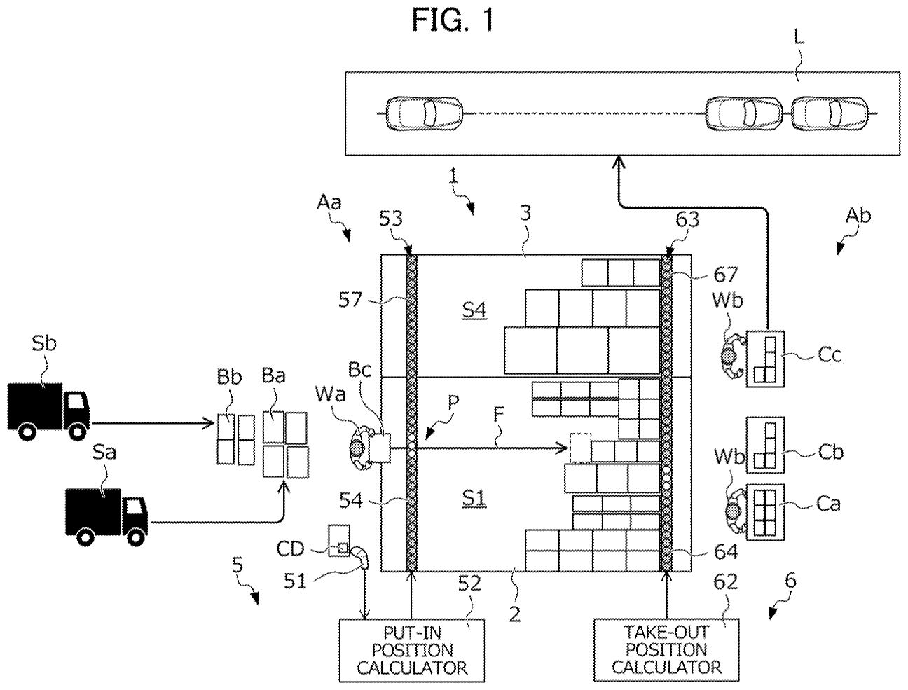

FIG. 1 is a diagram schematically showing a plane configuration of a bucket management system 1, a warehousing area Aa where a worker Wa performs warehousing work, and a set packing area Ab where a worker Wb performs set packing work according to the present embodiment.

The worker Wa performs warehousing work of arranging buckets Ba, Bb, and Bc as parts boxes carried in from the outside by parts manufacturers Sa and Sb, at predetermined positions. Inside each of the buckets Ba, Bb, and Bc, a plurality of vehicle parts are included. Though the shapes of the buckets Ba, Bb, and Bc are common in being rectangular in plan view, the sizes depend on the types of content.

The worker Wb performs set packing work of taking out vehicle parts for one vehicle from the plurality of buckets Ba, Bb, and Bc arranged at the predetermined positions after the warehousing work by the worker Wa, confirming whether the quality thereof is good or not, and loading the vehicle parts onto set pack carriages Ca, Cb, and Cc. The set pack carriages Ca, Cb, and Cc prepared through the set packing work by the worker Wb are delivered to a vehicle manufacturing line L for continuously producing vehicles of different models in predetermined lot units.

The bucket management system 1 is provided between the warehousing area Aa and the set packing area Ab and manages arrangement positions of buckets put in by the warehousing work by the worker Wa. More specifically, the bucket management system 1 is provided with a multi-stage chute 2 and a single-stage chute 3 that are provided between the warehousing area Aa and the set packing area Ab and temporarily store the plurality of buckets Ba, Bb, and Bc put in by the worker Wa, a put-in position indicator 5 that indicates a put-in position P for the bucket Bc that is a put-in target, to the worker Wa who performs warehousing work, and a take-out position indicator 6 that indicates a take-out position for a bucket that is a take-out target, to the worker Wb who performs set packing work.

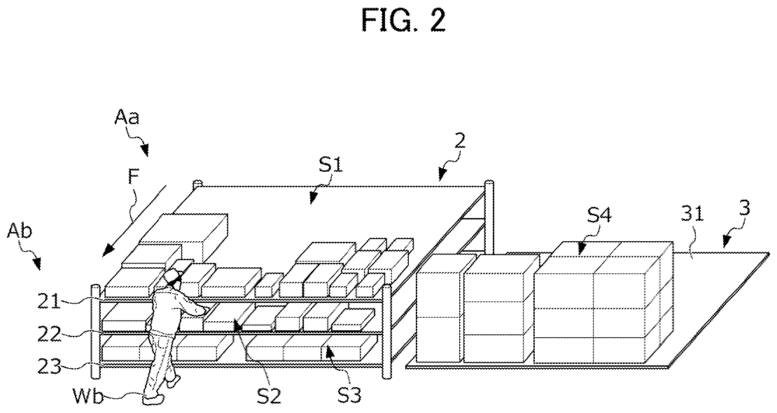

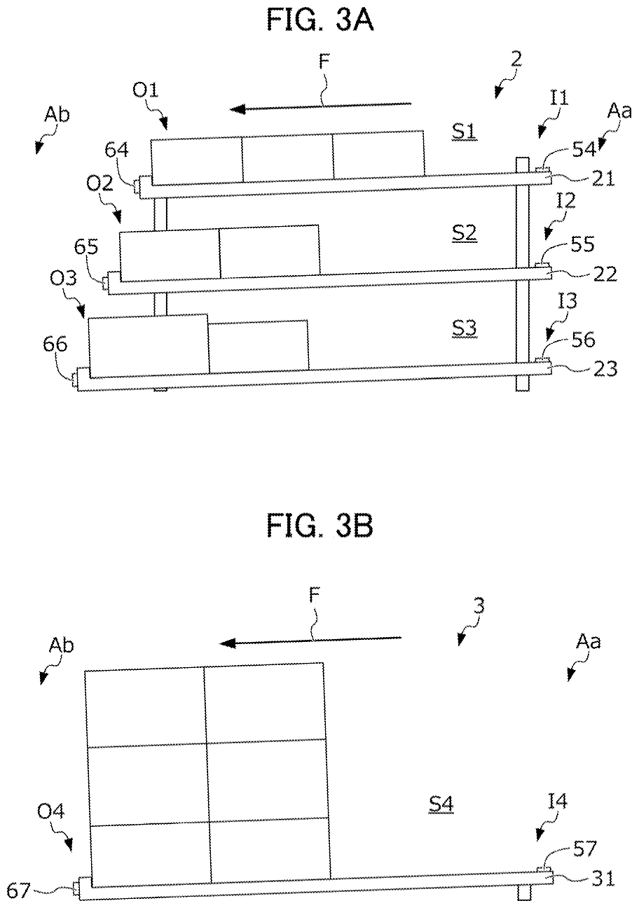

FIG. 2 is a perspective view of the multi-stage chute 2 and the single-stage chute 3 seen from the set packing area Ab side. FIG. 3A is a side view of the multi-stage chute 2, and FIG. 3B is a side view of the single-stage chute 3.

As shown in FIG. 2, the multi-stage chute 2 and the single-stage chute 3 are provided side by side along a width direction between the warehousing area Aa and the set packing area Ab. The multi-stage chute 2 is in a three-stage structure in which an upper-stage shelf board 21, a middle-stage shelf board 22, and a lower-stage shelf board 23 are stacked along a vertical direction. Though description will be made on a case where the multi-stage chute 2 is in the three-stage structure in the present embodiment, the number of stages of the multi-stage chute 2 is not limited thereto. The single-stage chute 3 is provided with one shelf board 31.

Each of the shelf boards 21 to 23, and 31 is in a rectangular shape in plan view, and a plurality of buckets can be placed on the top surface thereof. That is, spaces on the top portions of the shelf boards 21 to 23, and 31 are an upper-stage storage area S1, a middle-stage storage area S2, a lower-stage storage area S3, and a large storage area S4, each of which is for storing a plurality of buckets.

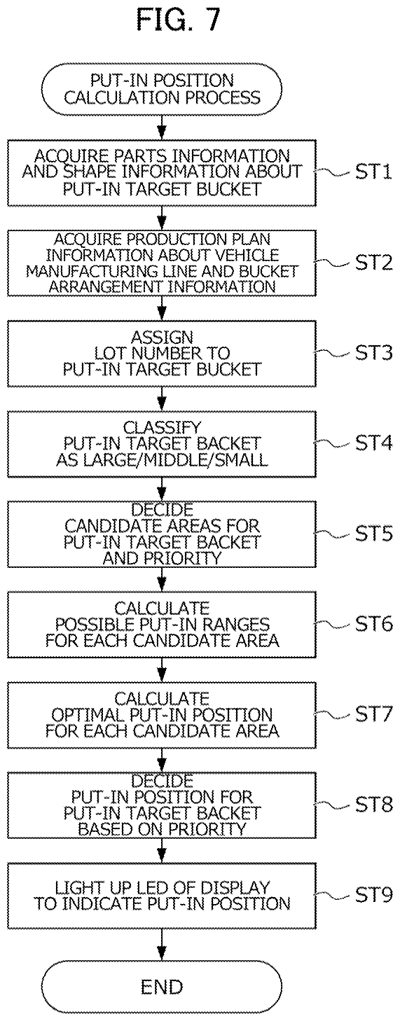

As described later with reference to FIG. 7 and the like, large-size buckets are preferentially stored into the large storage area S4 of the single-stage chute 3 in consideration of workability of the workers Wa and Wb. When the three storage areas S1 to S3 formed in the multi-stage chute 2 are compared, the upper-stage storage area S1 and the lower-stage storage area S3 are the best and the worst, respectively, in the workability of the workers Wa and Wb. Therefore, small size buckets are preferentially stored into the upper-stage storage area S1, and middle-size buckets are preferentially stored into the middle-stage storage area S2.

As shown in FIGS. 3A and 3B, the warehousing area Aa sides of the shelf boards 21, 22, 23, and 31 are put-in areas I1, I2, I3, and I4 where the worker who performs the warehousing work puts in buckets, respectively. The set packing area Ab sides of the shelf boards 21, 22, 23, and 31 are take-out areas O1, O2, O3, and O4 where the worker who performs the set packing work takes out vehicle parts from buckets stored in the storage areas S1, S2, S3, and S4, respectively. The put-in areas I1 to I4 and the take-out areas O1 to O4 extend mutually in parallel along the width direction and mutually face along a line direction that crosses the width direction. That is, between the put-in areas I1 to I4 and the take-out areas O1 to O4 of the shelf boards 21, 22, 23, and 31, the storage areas S1 to S4 for storing buckets put into the put-in areas I1 to I4 are provided, respectively.

The shelf boards 21 to 23, and 31 are slightly sloped from the put-in areas I1 to I4 sides toward the take-out areas O1 to O4 sides, respectively. More specifically, the take-out areas O1 to O4 sides of the shelf boards 21 to 23, and 31 are slightly lower than the put-in areas I1 to I4 sides, respectively. Therefore, buckets put into the put-in areas I1 to O4 are automatically conveyed to the take-out areas O1 to O4 sides, respectively, by their own weights along a conveying direction F parallel to the line direction until reaching the take-out areas O1 to O4 of the storage areas S1 to S4 or until coming into contact with buckets put in earlier. Therefore, buckets put into the put-in areas I1 to I4 are stored in the storage areas S1 to S4 in a state of being stacked in lines and collected on the take-out areas O1 to O4 sides, respectively, as shown in FIGS. 3A and 3B.

Each of the put-in areas I1 to I4 and the take-out areas O1 to O4 extends over a plurality of buckets along the width direction. Therefore, as shown in FIG. 2, in each of the storage areas S1 to S4, a plurality of bucket lines, each of which is configured by stacking a plurality of buckets along a conveying direction F, can be arranged.

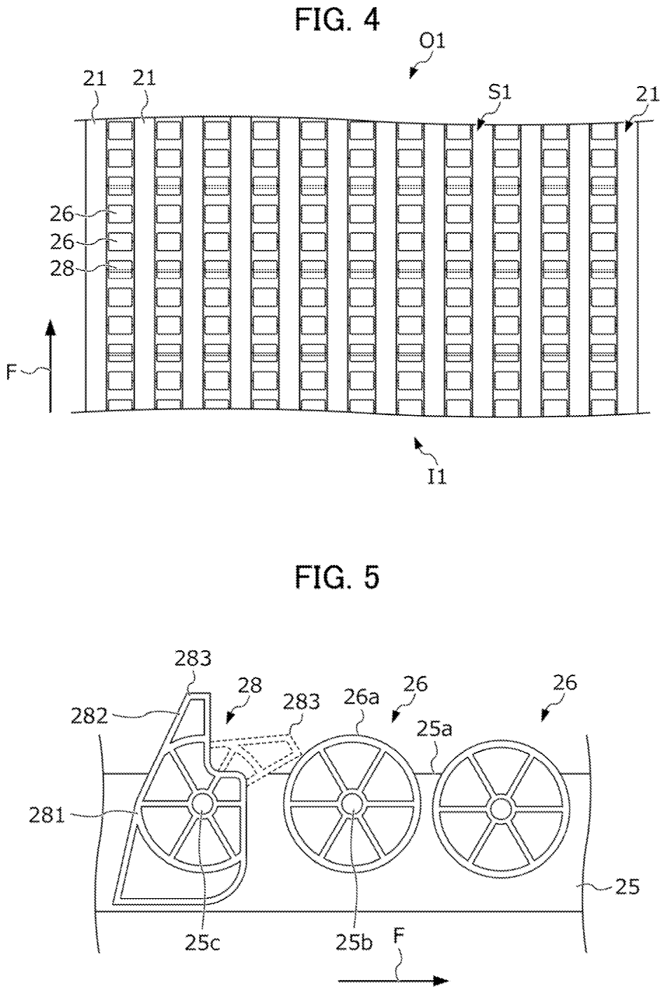

FIG. 4 is a plan view of the shelf board 21, and FIG. 5 is a sectional view along a line V-V parallel to the conveying direction F of the shelf board 21. Since configurations of the shelf boards 22, 23, and 31 are almost the same as the configuration of the shelf board 21, detailed description thereof will be omitted below.

As shown in FIG. 4, the upper-stage shelf board 21 is provided with a plurality of support rails 25 extending along the conveying direction F, and a plurality of rollers 26 and a plurality of stoppers 28 that are provided among the plurality of support rails 25, and are in a rectangular shape in plan view. In FIG. 4, the upper side of the upper-stage shelf board 21 is the take-out area O1 extending along the width direction that crosses the conveying direction F, and in FIG. 4, the lower side is the put-in area I1 extending along the width direction.

The support rails 25 are arranged at almost regular intervals along the width direction that crosses the conveying direction F. The plurality of rollers 26 and the plurality of stoppers 28 are arranged in lines along the conveying direction F among the support rails 25. FIG. 2 shows a case where two rollers 26 and one stopper 28 are assumed as one set, and a plurality of sets are arranged in a line between two support rails 25. The number of rollers 26 and stopper 28 constituting each set, however, is not limited to the above. The support rails 25 rotatably support the plurality of rollers 26 by rotation shafts 25b that are almost parallel to the width direction, and pivotally support the plurality stoppers 28 by pivot shafts that are almost parallel to the width direction.

As shown in FIG. 5, each roller 26 is in a cylindrical shape and is pivotally supported around the rotation shaft 25b extending along the width direction, with a part of its outer surface 26a being exposed from top surfaces 25a of the support rails 25. Therefore, a bucket B put into the put-in area I1 moves toward the take-out area O1 side along the conveying direction F, causing the rollers 26 to rotate.

As shown in FIG. 5, each stopper 28 is provided with an approximately cylindrical body 281, and a claw portion 282 protruding radially outward from an outer surface 281a of the body 281. The stopper 28 is pivotally supported by the support rails 25 in a state of a tip portion 283 of the claw portion 282 being exposed from the top surfaces 25a of the support rails 25. More specifically, the support rails 25 pivotally support the stopper 28 around a pivot shaft 25c extending along the width direction, and in FIG. 5, counterclockwise energize the stopper 28 by energizing members not shown.

Therefore, in a state in which external force from the put-in area I1 side toward the take-out area O1 side along the conveying direction F does not act on the claw portion 282 of the stopper 28, the claw portion 282 of the stopper 28 is kept in a state of standing by the energizing members not shown as indicated by solid lines in FIG. 5. That is, in this state, the tip portion 283 of the claw portion 282 of the stopper 28 is kept in a state of protruding to the upper side of the outer surfaces 26a of the rollers 26 in the vertical direction.

When the external force from the put-in area I1 side toward the take-out area O1 side along the conveying direction F acts on the claw portion 282 of the stopper 28, the external force causes the claw portion 282 of the stopper 28 to fall to the put-in area I1 side as indicated by broken lines in FIG. 5. That is, in this state, the tip portion 283 of the claw portion 282 of the stopper 28 is flush with the outer surfaces 26a of the rollers 26.

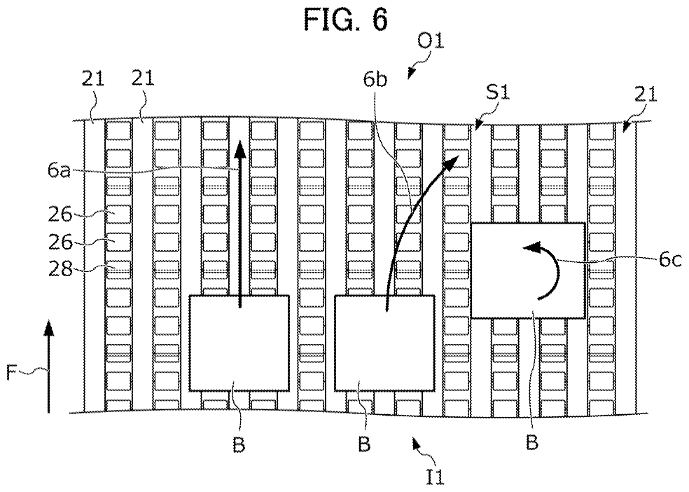

Therefore, the stoppers 28 act as a restriction mechanism that, in the state in which the external force does not act, allows the bucket B conveyed from the put-in area I1 side toward the take-out area O1 side in the storage area S1 to perform only movement along the conveying direction F (see an arrow 6a in FIG. 6) but restricts movement along the width direction (see an arrow 6b in FIG. 6) and rotation in plan view (see an arrow 6c in FIG. 6). Therefore, the bucket B put into the put-in area I1 is conveyed toward the take-out area O1 side along the conveying direction F, keeping the position along the width direction and the posture in plan view.

Returning to FIG. 1, the put-in position indicator 5 is provided with a bucket information reader 51 that can be operated by the worker Wa in the warehousing area Aa, a put-in position calculator 52, which is a computer connected to the bucket information reader 51, and a put-in position display 53 provided at a position where it can be visually confirmed by the worker Wa in the warehousing area Aa. By using the devices 51 to 53, the put-in position indicator 5 indicates, to the worker Wa, the put-in position P for the put-in target bucket Bc, which is a bucket the worker Wa is going to put in, along the width direction in any of the put-in areas I1 to I4.

To each of the buckets Ba, Bb, and Bc carried in from the outside, a two-dimensional code CD is attached. The two-dimensional code CD is, for example, a QR code (registered trademark), and is obtained by encoding parts information such as the type and number of vehicle parts included inside of each bucket, and shape information about the bucket such as dimensions and shape.

In response to an operation by the worker Wa, the bucket information reader 51 reads the two-dimensional code CD of the put-in target bucket Bc and transmits the read code data to the put-in position calculator 52.

The put-in position display 53 is provided with displays 54, 55, 56, and 57 provided along the put-in areas I1, I2, I3, and I4, respectively (see FIGS. 3A and 3B). Each of the displays 54 to 57 is provided with a plurality of LEDs arranged in a strip, the strip being from one end to the other end of each of the put-in areas I1 to I4 extending along the width direction. As shown in FIG. 1, the displays 54 to 57 are capable of lighting up only LEDs within a particular section, among the plurality of LEDs arranged along the put-in areas I1 to I4, respectively, as a put-in position in response to a calculation result of the put-in position calculator 52. That is, by lighting up only the LEDs within the particular section, among the plurality of LEDs constituting any of the displays 54 to 57, the put-in position calculator 52 indicates the put-in position P for the put-in target bucket Bc to the worker Wa.

The put-in position calculator 52 calculates the put-in position P for the put-in target bucket Bc based on code data of the put-in target bucket Bc, production plan information about the vehicle manufacturing line L, bucket arrangement information about each of the storage areas S1 to S4, being triggered by the code data of the put-in target bucket Bc being read by the bucket information reader 51, and lights up only LEDs within a section corresponding to the calculated put-in position P, among the plurality of LEDs constituting the displays 54 to 57.

FIG. 7 is a flowchart showing a specific procedure for a put-in position calculation process for calculating the put-in position for the put-in target bucket by the put-in position calculator. The process shown in FIG. 7 is started by the put-in position calculator, being triggered by the code data of the put-in target bucket being read by the bucket information reader 51.

First, at step ST1, the put-in position calculator acquires parts information about vehicle parts in the put-in target bucket and shape information about the put-in target bucket based on the code data transmitted from the bucket information reader, and proceeds to step ST2.

Next, at step ST2, the put-in position calculator acquires the production plan information about the vehicle manufacturing line, bucket arrangement information about each of the storage areas S1 to S4, and proceeds to step ST3.

Here, the bucket arrangement information about the storage areas S1 to S4 include position information about an arrangement position of each bucket stored in the storage areas S1 to S4, respectively, shape information about the bucket, and a lot number described later, which is assigned to the bucket, and the like. As described above, buckets put into the put-in areas I1 to I4 are automatically conveyed along the conveying direction until reaching the take-out areas O1 to O4 or coming into contact with buckets put in earlier, respectively. Therefore, the bucket arrangement information about the storage areas S1 to S4 can be calculated by calculation by the put-in position calculator based on shape information, put-in position information, and lot numbers of buckets that have been already put into the put-in areas I1 to I4, respectively, and shape information, take-out position information, and lot numbers of buckets that have been already taken out from the take-out areas O1 to O4, respectively. If cameras are provided for the storage areas S1 to S4, respectively, the bucket arrangement information about the storage areas S1 to S4 can be acquired based on image data photographed by the cameras, respectively.

Next, at step ST3, the put-in position calculator assigns a lot number to the put-in target bucket based on the parts information about the put-in target bucket acquired at step ST1 and the production plan information acquired at step ST2, and proceeds to step ST4.

Next, at step ST4, the put-in position calculator classifies the put-in target bucket as a large-size bucket, a middle-size bucket, or a small-size bucket based on the shape information about the put-in target bucket acquired at step ST1, and proceeds to step ST5.

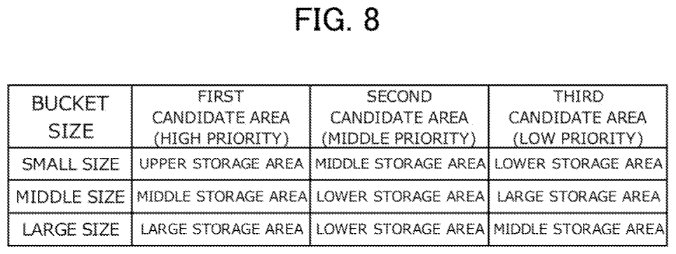

Next, at step ST5, the put-in position calculator determines candidates for a storage area for storing the put-in target bucket (hereinafter referred to as “candidate areas”) and priority based on a classification result in the step ST4, and proceeds to step ST6. More specifically, the put-in position calculator 52 determines first to third candidate areas and priority by referring to a table shown in FIG. 8. According to the table example shown in FIG. 8, if the put-in target bucket is classified as a small-size bucket, the upper-stage storage area, the middle-stage storage area, and the lower-stage storage area are determined as the candidate areas in descending order of priority. If the put-in target bucket is classified as a middle-size bucket, the middle-stage storage area, the lower-stage storage area, and the large storage area are determined as the candidate areas in descending order of priority. If the put-in target bucket is classified as a large-size bucket, the large storage area, the lower-stage storage area, and the middle-stage storage area are determined as the candidate areas in descending order of priority.

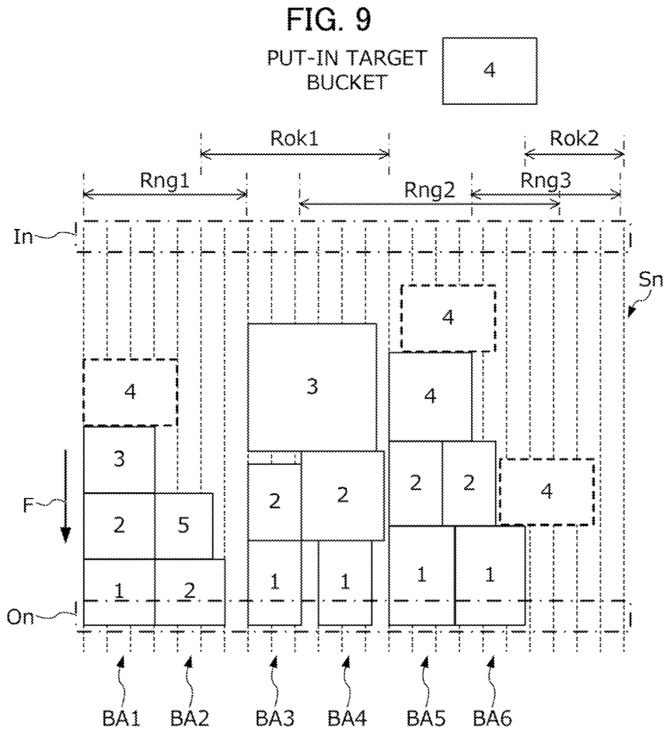

Next, at step ST6, the put-in position calculator calculates possible put-in ranges for each of the candidate areas determined at step ST5, based on the shape information about the put-in target bucket acquired at step ST1, the bucket arrangement information acquired at step ST2, and the lot number assigned to the put-in target bucket, and proceeds to step ST7. Here, a specific procedure for the put-in position calculator calculating the possible put-in ranges will be described with reference to an example of FIG. 9.

FIG. 9 is a diagram showing an example of the possible put-in ranges. More specifically, FIG. 9 is a diagram schematically showing a plane configuration of a candidate area Sn and a plurality of buckets stored in the candidate area Sn. In FIG. 9, a numeral attached to each bucket indicates a lot number. In the example of FIG. 9, it is assumed that the lot number assigned to the put-in target bucket is “4”.

FIG. 9 shows an example in which, before the put-in target bucket is put into a put-in area In, a first bucket line BA1, a fourth bucket line BA4, a fifth bucket line BA5, and a sixth bucket line BA6, each of which is configured by stacking three buckets, and a second bucket line BA2 and a third bucket line BA3, each of which is configured by stacking two buckets, are stored in the candidate area Sn. The first bucket line BA1 is configured by stacking buckets with lot numbers 1, 2, and 3 in that order from the take-out area On side to the put-in area In side; the second bucket line BA2 is configured by stacking buckets with lot numbers 2 and 5; the third bucket line BA3 is configured by stacking buckets with lot numbers 1 and 2; the fourth bucket line BA4 is configured by stacking buckets with lot numbers 1, 2, and 3; the fifth bucket line BA5 is configured by stacking buckets with lot numbers 1, 2, and 4; and the sixth bucket line BA6 is configured by stacking buckets with lot numbers 1, 2, and 4.

The put-in position calculator extracts a range that satisfies all of first to third put-in permission conditions described below, in the put-in area In of the candidate area Sn, as the possible put-in range, based on the shape information about the put-in target bucket acquired at step ST1, the bucket arrangement information acquired at step ST2, and the lot number assigned to the put-in target bucket at step ST3.

The first put-in permission condition is that, in the candidate area Sn, a plurality of buckets constituting each bucket line should be lined up in order of lot number from the take-out area On side toward the put-in area In side. The second put-in permission condition is that, in the candidate area Sn, buckets with the same lot number should not be lined up along the conveying direction F. The third put-in permission condition is that, in the case of arranging the put-in target bucket in a state of being stacked on stacking target buckets already existing in the candidate area along the conveying direction F, a rate of overlap of the put-in target bucket relative to a stacking target bucket in front on the take-out area On side should be equal to or above a predetermined threshold (for example, 50%).

In the example shown in FIG. 9, if the put-in target bucket is put into a range Rng1 of the put-in area In, the put-in target bucket is arranged at the end of the first bucket line BA1 or the second bucket line BA2. If the put-in target bucket is put into the range Rng1, however, the put-in target bucket with the lot number 4 is arranged on the put-in area In side relative to the bucket with the lot number 5 at the end of the second bucket BA2 along the conveying direction F. That is, in this case, a plurality of buckets constituting each bucket line in the candidate area Sn are not lined up in order of the lot number from the take-out area On side toward the put-in area In side. Therefore, the put-in target bucket with the lot number 4 does not reach the take-out area On unless the bucket with the lot number 5 is removed. Therefore, since the range Rng1 does not satisfy the first put-in permission condition in the example shown in FIG. 9, the put-in position calculator excludes the range Rng1 from the possible put-in ranges.

In the example shown in FIG. 9, if the put-in target bucket is put into a range Rng2 in the put-in area In, the put-in target bucket is arranged at the end of the fifth bucket line BA5. If the put-in target bucket is put into the range Rng2, however, the put-in target bucket with the lot number 4 is arranged on the put-in area In side relative to the bucket with the lot number 4 at the end of the fifth bucket BA5 along the conveying direction F. That is, in this case, in the candidate area Sn, buckets with the same lot number are lined up along the conveying direction F. Therefore, the put-in target bucket with the lot number 4 does not reach the take-out area On unless the bucket with the bucket number 4 is removed. Therefore, in the example shown in FIG. 9, since the range Rng2 does not satisfy the second put-in permission condition, the put-in position calculator excludes the range Rng2 from the possible put-in ranges.

In the example shown in FIG. 9, if the put-in target bucket is put into a range Rng3 in the put-in area In, the put-in target bucket comes into contact with any of the bucket with the lot number 2 and the bucket with the lot number 1 constituting the sixth bucket line BA6. If the put-in target bucket is put into the range Rng3, however, the overlap rate of the put-in target bucket relative to the bucket with the lot number 2 or the bucket with the lot number 1 in front on the take-out area On side along the conveying direction F is below the predetermined threshold (for example, 50%). In this case, the width of the bucket line along the width direction in the candidate area Sn becomes long, and the put-in target bucket is stacked in an unstable state. Therefore, in the example shown in FIG. 9, since the range Rng3 does not satisfy the third put-in permission condition, the put-in position calculator excludes the range Rng3 from the possible put-in ranges.

In the example shown in FIG. 9, if the put-in target bucket is put into a range Rok1 in the put-in area In, the put-in target bucket is arranged at the end of the third bucket line BA3 or the fourth bucket line BA4. As described above, the second bucket line BA2 is configured by arranging the buckets with the bucket numbers 1 and 2 in that order, and the third bucket line BA3 is configured by arranging the buckets with the bucket numbers 1, 2, and 3 in that order. Therefore, if the put-in target bucket with the lot number 4 is put into the range Rok1, a plurality of buckets constituting each bucket line in the candidate area Sn are arranged in order of the lot number from the take-out area On side toward the put-in area In side. Therefore, in the example shown in FIG. 9, since the range Rok1 satisfies all the first to third put-in permission conditions, the put-in position calculator calculates the range Rok1 as a possible put-in range.

Further, in the example shown in FIG. 9, if the put-in target bucket is put into a range Rok2 in the put-in area In, the put-in target bucket reaches the take-out area On without coming into contact with a bucket put in earlier. Therefore, in the example shown in FIG. 9, since the range Rok2 also satisfies all the first to third put-in permission conditions, the put-in position calculator extracts the range Rok2 as a possible put-in range.

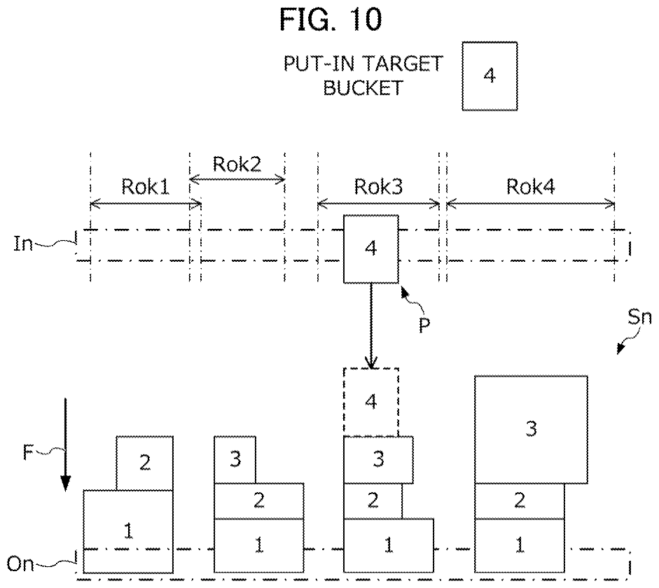

Returning to FIG. 7, at step ST7, the put-in position calculator calculates one optimal put-in position for the put-in target bucket, for each candidate area, from the possible put-in range calculated for each candidate area at step ST6, based on the shape information about the put-in target bucket acquired at step ST1, the bucket arrangement information acquired at step ST2, and the lot number assigned to the put-in target bucket at step ST3, and proceeds to step ST8. Hereinafter, an optimal put-in position in the first candidate area, an optimal put-in position in the second candidate area, and an optimal put-in position in the third candidate area will be referred to as a first optimal put-in position, a second optimal put-in position, and a third optimal put-in position. Here, a specific procedure for the put-in position calculator calculating an optimal put-in position from an put-in permission range will be described with reference to an example of FIG. 10.

FIG. 10 is a diagram for illustrating the procedure for the put-in position calculator calculating an optimal put-in position. More specifically, FIG. 10 is a diagram schematically showing a plane configuration of the candidate area Sn and a plurality of buckets stored in the candidate area Sn. In FIG. 10, a numeral attached to each bucket indicates a lot number. In the example of FIG. 10, it is assumed that the lot number assigned to the put-in target bucket is “4”. Further, FIG. 9 shows a case where ranges Rok1, Rok2, Rok3, and Rok4 in the put-in area In of the candidate area Sn are calculated as possible put-in ranges.

The put-in position calculator calculates a put-in position that satisfies the most conditions among first to fourth optimal conditions described below, in each possible put-in ranges, as an optimal put-in position, based on the shape information about the put-in target bucket acquired at step ST1, the bucket arrangement information acquired at step ST2, and the lot number assigned to the put-in target bucket at step ST3.

The first optimal condition is that, in the candidate area Sn, the put-in position should be such that none of lot numbers of a plurality of buckets constituting each bucket line is skipped. The second optimal condition is that the put-in position should be such that the length of each bucket line formed in the candidate area Sn along the conveying direction F should be the shortest. The third optimal condition is that the put-in position should be such that, in the case of arranging the put-in target bucket in a state of being stacked on stacking target buckets already existing in the candidate area along the conveying direction F, a rate of overlap of the put-in target bucket relative to a stacking target bucket in front on the take-out area On side should be the highest. The fourth optimal condition is that the put-in position should be such that, in the case of arranging the put-in target bucket in a state of being stacked on stacking target buckets already existing in the candidate area along the conveying direction F, a left side face of the put-in target bucket on the left side seen from the take-out area On side should be flush with left side faces of the stacking target buckets.

In the example shown in FIG. 9, if the put-in target bucket is put into the possible put-in range Rok1 of the put-in area In, buckets are arranged in order of lot numbers 1, 2, and 4 from the take-out area On side to the put-in area In side in the candidate area Sn. That is, a lot number is skipped. Therefore, no put-in position in the possible put-in range Rok1 satisfies the first optimal condition. In comparison, all put-in positions in the possible put-in ranges Rok2 to 4 satisfy the first optimal condition.

In the example shown in FIG. 9, a length of a bucket line formed in the candidate area Sn along the conveying direction F when the put-in target bucket is put into the possible put-in range Rok4 of the put-in area In is longer than the case of putting the put-in target bucket into any of the possible put-in ranges Rok1 to Rok3 of the put-in area In. Therefore, no put-in position in the possible put-in range Rok4 satisfies the second optimal condition. In comparison, all put-in positions in the possible put-in ranges Rok1 to Rok3 satisfy the second optimal condition. Note that, by imposing such a second optimal condition as a condition for extracting an optimal put-in position from a possible put-in range, it is possible to reduce variation in length along the conveying direction F among a plurality of bucket lines formed in a candidate area.

In the example shown in FIG. 9, if the put-in target bucket is put into any of the possible put-in ranges Rok1, Rok3, and Rok4 of the put-in area In, the rate of overlap of the put-in target bucket relative to a stacking object bucket in front on the take-out area On side can be 100%. In comparison, when the put-in target bucket is put into the possible put-in ranges Rok2, the rate of overlap of the put-in target bucket relative to a stacking object bucket in front on the take-out area On side cannot be 100%. Therefore, no put-in position in the possible put-in range Rok2 satisfies the third optimal condition. In comparison, a put-in position satisfying the third optimal condition exists in each of the possible put-in ranges Rok1, Rok3, and Rok4.

As described above, in the example shown in FIG. 9, a put-in position only in the possible put-in range Rok3 among the four possible put-in ranges Rok1 to Rok4 satisfies all the first to third optimal conditions. Therefore, in the example shown in FIG. 9, the put-in position calculator calculates a put-in position P that satisfies all the first to fourth optimal conditions, more specifically, such a put-in position P that the left-side face of the put-in target bucket is flush with left-side faces of stacking target buckets, in the possible put-in range Rok3, as an optimal put-in position.

Returning to FIG. 7, at step ST8, the put-in position calculator decides one of the optimal put-in positions calculated for the candidate areas, respectively, at step ST7, as a put-in position for the put-in target bucket, based on the priority decided at step ST5, and proceeds to step ST9.

More specifically, the put-in position calculator calculates, for each candidate area, a distance between a position that the put-in target bucket reaches when the put-in target bucket is put into the optimal put-in position and the take-out area along the conveying direction (hereinafter also referred to as “a reach distance), and judges whether the calculated reach distance is below a threshold specified for the candidate area. Further, the put-in position calculator 52 decides an optimal put-in position of a candidate area with the highest priority, among candidate areas for which the reach distance is below the threshold, as the put-in position for the put-in target bucket. When the reach distances of all the candidate areas are above the threshold, the put-in position calculator decides an optimal put-in position of a candidate area with the shortest reach distance as the put-in position for the put-in target bucket.

At step ST9, the put-in position calculator indicates, to the worker, the put-in position for the put-in target bucket by lighting up only LEDs corresponding to the put-in position P decided at step ST8 among the plurality of LEDs constituting the displays 54 to 57 provided for the put-in areas I1 to I4.

Returning to FIG. 1, the take-out position indicator 6 is provided with a take-out position display 63 provided at a position where it can be visually confirmed by the worker Wb in the set packing area Ab, and a take-out position calculator 62, which is a computer connected to the take-out position display 63. The take-out position indicator 6 indicates a take-out position of a take-out target bucket, which is a bucket including vehicle parts targeted by set packing work by the worker Wb, along the width direction of the take-out areas O1 to O4, by using the devices 62 to 63.

The take-out position display 63 is provided with displays 64, 65, 66, and 67 provided along the take-out areas O1, O2, O3, and O4, respectively (see FIGS. 3A and 3B). Each of the displays 64 to 67 is provided with a plurality of LEDs arranged in a strip, the strip being from one end to the other end of each of the take-out areas O1 to O4 extending along the width direction. The displays 64 to 67 are capable of lighting up only LEDs within a particular section, among the plurality of LEDs arranged along the take-out areas O1 to O4, respectively, as a take-out position in response to a calculation result of the take-out position calculator 62. The take-out position calculator 62 acquires bucket arrangement information about each of the storage areas S1 to S4 by the same procedures as step ST2 in FIG. 7, and, by lighting up only LEDs within a particular section, among the plurality of LEDs constituting any of the displays 64 to 67, based on the arrangement information, indicates the put-in position for the take-out target bucket to the worker Wb.

According to the bucket management system 1 and the bucket position management method according to the present embodiment, the following effects are obtained.

(1) A bucket management system 1 according to the present invention includes: the multi-stage chute 2 and the single-stage chute 3 including put-in areas I1 to I4 and take-out areas O1 to O4, the put-in areas I1 to I4 and the take-out areas O1 to O4 extending along a width direction, the put-in areas facing the take-out areas, respectively, in a line direction, respectively, and the multi-stage chute 2 and the single-stage chute 3 conveying buckets put into the put-in areas I1 to I4, along the conveying direction F parallel to the line direction in the storage areas S1 To S4 until the buckets reach the take-out areas O1 to O4 or come into contact with buckets put in earlier; and a put-in position indicator 5 indicating a put-in position P for a put-in target bucket along the width direction in any of the put-in areas I1 to I4. In each of the storage areas S1 to S4, a plurality of lines of buckets can be arranged along the width direction, each of the plurality of lines of buckets being configured by stacking a plurality of buckets along the conveying direction F; and the put-in position indicator 5 indicates the put-in position P based on a lot number assigned to the put-in target bucket and buckets arrangement information about each of the storage areas S1 to S4. Therefore, according to the bucket management system 1, the worker Wa can arrange a put-in target bucket at a position appropriate for a lot number of the put-in target bucket, only by putting the put-in target bucket at the put-in position P indicated by the put-in position indicator 5, in any of the put-in areas I1 to I4 extending in the width direction. More specifically, for example, when a plurality of buckets are arranged in each of the storage areas S1 to S4 so that a bucket with a low lot number is located at the front of each of lines of buckets, in other words, so that buckets with low lot numbers are arranged along the take-out areas O1 to O4, the worker Wb can, in the subsequent set packing process, take out necessary vehicle parts from the buckets arranged in the take-out areas O1 to O4, among a plurality of buckets arranged in the storage areas S1 to S4, and, therefore, it is possible to facilitate the set packing work. Further, in the bucket management system 1, it is possible to, by making it possible to arrange a plurality of lines of buckets in each of the storage areas S1 to S4, efficiently arrange buckets of various sizes in each of the storage areas S1 to S4. Therefore, it is also possible to reduce the storage areas S1 to S4.

(2) In the bucket management system 1, the put-in position indicator 5 indicates the put-in position P based on shape information about the put-in target bucket in addition to the lot number and the arrangement information. Thereby, it is possible to more efficiently arrange buckets of various sizes in the storage areas S1 to S4.

(3) In the bucket management system 1, the put-in position indicator 5 indicates the put-in position P for the put-in target bucket so that, in the storage areas S1 to S4, a plurality of buckets constituting each of the lines of buckets are arranged in order of the lot number from the take-out areas O1 to O4 sides to the put-in area I1 to I4 sides. Thereby, it is possible to arrange a bucket with the lowest lot number at the front of each of a plurality of lines arranged in the storage areas S1 to S4, and, therefore, it is possible to facilitate the subsequent set packing work.

(4) In the bucket management system 1, the put-in position indicator 5 indicates the put-in position P so that buckets with the same lot number are not arranged along the conveying direction F in the storage areas S1 to S4. Thereby, the worker Wa who performs the set packing work can cause only what is at the front of each of a plurality of lines of buckets arranged in the storage areas S1 to S4, in other words, only those arranged in the take-out areas O1 to O4 to be work targets, and, therefore, it is possible to further facilitate the set packing work.

(5) In the bucket management system 1, the put-in position indicator 5 indicates the put-in position P so that, in a case of arranging the put-in target bucket in a state of being stacked on stacking buckets already existing in each of the storage areas S1 to S4, along the conveying direction F, a rate of overlap of the put-in target bucket relative to a stacking target bucket in front on each of the take-out areas O1 to O4 sides, among the stacking target buckets, is equal to or above a predetermined threshold. Thereby, the width of each of lines of buckets in the storage areas S1 to S4 can be reduced as far as possible, and, therefore, it is possible to further reduce the storage areas S1 to S4. Further, thereby, it is also possible to prevent buckets stacked on stacking target buckets on the put-in area I1 to I4 sides along the conveying direction F from getting out of a line of buckets.

(6) In the bucket management system 1, the put-in position indicator 5 indicates the put-in position P so that variation in length along the conveying direction F, among the plurality of lines of buckets existing in the storage areas S1 to S4 is reduced. Thereby, the lengths of the storage areas S1 to S4 along the conveying direction F can be shortened, and, therefore, it is possible to further reduce the storage areas S1 to S4.

(7) In the bucket management system 1, each of the chutes 2 and 3 includes a plurality of stoppers 28 that restrict buckets conveyed from the put-in areas I1 to I4 sides toward the take-out areas O1 to O4 sides in the storage areas S1 to S4 in movement along the width direction and rotation in plan view. Thereby, it is possible to prevent a bucket put into any of the put-in areas I1 to I4 from moving to an unintended place.

(8) In the bucket management system 1, a take-out position indicator 6 indicates a take-out position of a take-out target bucket along the width direction in each of the take-out areas O1 to O4, based on the bucket arrangement information about each of the storage areas S1 to S4. Thereby, the worker Wb who performs the set packing work can take out a necessary vehicle part only by taking out the vehicle part from a bucket at a take-out position indicated by the take-out position indicator 6, and, therefore, it is possible to further facilitate the set packing work.

(9) In a bucket management method according to the present embodiment, by specifying the put-in position P for a put-in target bucket along the width direction in any of the put-in areas I1 to I4 based on a lot number assigned to the put-in target bucket and information about bucket arrangement in storage areas S1 to S4, the worker Wa can arrange the put-in target bucket at a position appropriate for the lot number only by putting the put-in target bucket at the indicated put-in position P in any of the put-in areas I1 to I4 extending in the width direction. Thereby, it is possible to facilitate the set packing work and reduce the storage areas S1 to S4.

(10) In the bucket management method, shape information about the put-in target bucket is acquired, and the put-in position P for the put-in target bucket is indicated based on the lot number, the arrangement information, and the shape information. Thereby, it is possible to more efficiently arrange buckets of various sizes in the storage areas S1 to S4.

One embodiment of the present invention has been described above. The present invention, however, is not limited thereto. Detailed configurations may be appropriately changed within a range of the spirit of the present invention.

### EXPLANATION OF REFERENCE NUMERALS

L Vehicle manufacturing line
Aa Warehousing area
Ab Set packing area
Wa, Wb Worker
Ca, Cb, Cc Set pack carriage
Ba, Bb Bucket
Bc Put-in target bucket
1 Bucket management system (parts box management system)
2 Multi-stage chute (chute)
21 Upper-stage shelf board
22 Middle-stage shelf board
23 Lower-stage shelf board
25 Support rail
26 Roller
28 Stopper
3 Single-stage chute
I1, I2, I3, I4, In Put-in area
O1, O2, O3, O4, On Take-out area
S1 Upper-stage storage area
S2 Middle-stage storage area
S3 Lower-stage storage area
S4 Large storage area
Sn Candidate area
5 Put-in position indicator
6 Take-out position indicator

1. A parts box management system comprising:
a chute comprising a put-in area and a take-out area, the put-in area and the take-out area extending along a width direction and facing each other in a line direction that crosses the width direction, and conveying a parts box put into the put-in area, along the line direction in a storage area between the put-in area and the take-out area until the parts box reaches the take-out area or comes into contact with a parts box put in earlier; and
a put-in position indicator indicating a put-in position for a put-in target parts box along the width direction in the put-in area, wherein
in the storage area, a plurality of lines of parts boxes can be arranged along the width direction, each of the plurality of lines of parts boxes being configured by stacking a plurality of parts boxes along the line direction; and
the put-in position indicator indicates the put-in position based on a lot number assigned to the put-in target parts box and parts boxes arrangement information about the storage area.

2. The parts box management system according to claim 1, wherein the put-in position indicator indicates the put-in position based on shape information about the put-in target parts box.

3. The parts box management system according to claim 1, wherein the put-in position indicator indicates the put-in position so that, in the storage area, the plurality of parts boxes constituting each of the lines of parts boxes are arranged in order of the lot number from the take-out area side toward the put-in area side.

4. The parts box management system according to claim 1, wherein the put-in position indicator indicates the put-in position so that parts boxes with a same lot number are not arranged along the line direction in the storage area.

5. The parts box management system according to claim 1, wherein the put-in position indicator indicates the put-in position so that, in a case of arranging the put-in target parts box in a state of being stacked on stacking target parts boxes already existing in the storage area, along the line direction, a rate of overlap of the put-in target parts box relative to a stacking target parts box in front on the take-out area side, among the stacking target parts boxes, is equal to or above a predetermined threshold.

6. The parts box management system according to claim 1, wherein the put-in position indicator indicates the put-in position so that variation in length along the line direction, among the plurality of lines of parts boxes existing in the storage area, is reduced.

7. The parts box management system according to claim 1, wherein the chute comprises a restriction mechanism that restricts a parts box conveyed from the put-in area side toward the take-out area side in the storage area in movement along the width direction and in rotation in plan view.

8. The parts box management system according to claim 1, further comprising a take-out position indicator indicating a take-out position of a take-out target parts box along the width direction in the take-out area, based on the parts boxes arrangement information about the storage area.

9. A parts box management method for managing arrangement positions of a plurality of parts boxes using a chute, the chutes comprising a put-in area and a take-out area, the put-in area and the take-out area extending along a width direction and facing each other in a line direction that crosses the width direction, and conveying a parts box put into the put-in area, along the line direction in a storage area between the put-in area and the take-out area until the parts box reaches the take-out area or comes into contact with a parts box put in earlier, the parts box management method comprising the steps of:
acquiring a lot number assigned to a put-in target parts box;
acquiring parts boxes arrangement information about the storage area; and
indicating a put-in position for the put-in target parts box along the width direction in the put-in area based on the lot number and the arrangement information; wherein
in the storage area, a plurality of lines of parts boxes can be arranged along the width direction, each of the plurality of lines of parts boxes being configured by stacking a plurality of parts boxes along the line direction.

10. The parts box management method according to claim 9, further comprising a step of acquiring shape information about the put-in target parts box; wherein
the put-in position is indicated based on the lot number, the arrangement information, and the shape information.
